(19) United States
(12) Patent Application Publication
(10) Pub. No.: US 2019/0025732 A1
(43) Pub. Date: Jan. 24, 2019

(54) ELECTROPHOTOGRAPHIC PRINTER AND PRINTING METHOD

(71) Applicant: MIMAKI ENGINEERING CO., LTD., Nagano (JP)

(72) Inventor: Masaru OHNISHI, NAGANO (JP)

(73) Assignee: MIMAKI ENGINEERING CO., LTD., Nagano (JP)

(21) Appl. No.: 16/029,664

(22) Filed: Jul. 9, 2018

(30) Foreign Application Priority Data
Jul. 19, 2017 (JP) 2017-140285

(51) Int. Cl. G03G 15/10; G03G 15/01

(52) U.S. Cl. CPC G03G 15/104; G03G 15/0121

(57) ABSTRACT

An electrophotographic printer and a printing method are provided that may achieve an improved image quality, while reducing the risk of a print target medium being deformed. The electrophotographic printer includes a first color printing means. The first color printing means includes a toner developing unit, a toner image transfer unit, and an ultraviolet irradiating-drying unit. The toner developing unit adsorbs a liquid toner containing an ultraviolet absorbent for absorption of ultraviolet light to a latent charge image so as to develop a toner image. The toner image transfer unit transfers the toner image onto a print target medium. The ultraviolet irradiating-drying unit dries the transferred toner image on the print target medium by ultraviolet irradiation to obtain a dried toner image.

### CROSS REFERENCE TO RELATED APPLICATIONS

This application claims the priority benefit of Japanese Patent Application No. 2017-140285, filed on Jul. 19, 2017. The entirety of the above-mentioned patent application is hereby incorporated by reference herein and made a part of this specification.

### TECHNICAL FIELD

This disclosure relates to an electrophotographic printer and a printing method.

### DESCRIPTION OF THE BACKGROUND ART

A known example of the conventional printing methods of image printing for target media, such as paper, is electrophotography (for example, Japanese Unexamined Patent Publication No. 2010-076334). The electrophotography refers to a printing method in which an image developed by applying toner to the surface of a photoconductor is transferred to a print target medium.

Patent Literature: Japanese Unexamined Patent Publication No. 2010-076334.

### SUMMARY

In the printing method described in Japanese Unexamined Patent Publication No. 2010-076334, dry electrophotography is employed. Toners conventionally used in dry electrophotographic printing are particulate toners. The particular toners are conventionally produced by pulverizing pigment components. The average particle sizes of such particulate toners are thus relatively large, approximately 5.5 μm, and their particles have shapes with a low degree of sphericity. Hence, improvement of image quality may be difficult with the printing method described in Japanese Unexamined Patent Publication No. 2010-076334.

In the printing method described in Japanese Unexamined Patent Publication No. 2010-076334, offset printing precedes the dry electrophotographic printing. In the offset printing, any region to which ink should not be applied is impregnated with water. In the printing method described in Japanese Unexamined Patent Publication No. 2010-076334 in which the print target medium is thus impregnated with water, some measures are taken to avoid evaporation of water impregnated into the print target medium and to avoid oversupply of thermal energy to the toner, with an aim to reduce the risk of the print target medium being deformed. In case of the occurrence of evaporation of water impregnated into the print target medium and oversupply of thermal energy to the toner, the print target medium may be likely to deform, possibly resulting in a poor image quality. The deformation of the print target medium may lead to other issues, for example, paper jam.

To address these issues of the known art, this disclosure provides an electrophotographic printer and a printing method that may achieve an improved image quality, while reducing the risk of a print target medium being deformed.

To address the issues of the known art and to serve the purpose of this disclosure, an electrophotographic printer is provided that includes: a toner developing unit that adsorbs a liquid toner containing an ultraviolet absorbent for absorption of ultraviolet light to a latent charge image so as to develop a toner image; a toner image transfer unit that transfers the toner image obtained by the toner developing unit onto a print target medium; and an ultraviolet irradiating-drying unit that irradiates the toner image with ultraviolet light so as to dry the toner image transferred on the print target medium.

In this configuration, the electrophotographic printer may be equipped with a plurality of the toner developing units, a plurality of the toner image transfer units, and a plurality of the ultraviolet irradiating-drying units that are respectively provided for a plurality of different colors. In the electrophotographic printer thus further characterized, a plurality of the toner images are sequentially dried per color on the print target medium so as to form a composite dried toner image including the plurality of the toner images dried and having the plurality of different colors on the print target medium.

The electrophotographic printer equipped with a plurality of the toner developing units, a plurality of the toner image transfer units, and a plurality of the ultraviolet irradiating-drying units respectively for a plurality of different colors may further include a fixing device that heats the print target medium on which the composite dried toner image is formed so as to fix the composite dried toner image onto the print target medium.

To address the issues of the known art and to serve the purpose of this disclosure, a printing method is provided that includes a toner developing step of developing a toner image through adsorption of a liquid toner including an ultraviolet absorbent that absorbs ultraviolet light; a toner image transfer step of transferring the toner image obtained in the toner developing step onto a print target medium; and an ultraviolet irradiating-drying step of irradiating the toner image with ultraviolet light so as to dry the toner image transferred on the print target medium. The printing method may include a plurality of the toner developing steps, a plurality of the toner image transfer steps, and a plurality of the ultraviolet irradiating-drying steps respectively for a plurality of different colors. In the printing method, a plurality of the toner images are sequentially dried per color on the print target medium so as to form a composite dried toner image including the plurality of the toner images dried and having the plurality of different colors on the print target medium.

In this configuration, the printing method may further include a fixing step of heating the print target medium on which the composite dried toner image is formed so as to fix the composite dried toner image onto the print target medium.

This disclosure provides an electrophotographic printer and a printing method that may achieve an improved image quality, while reducing the risk of a print target medium being deformed.

### BRIEF DESCRIPTION OF THE DRAWINGS

FIG. 1 is a schematic drawing of a structural overview of an electrophotographic printer according to an embodiment.

FIG. 2 is a schematic drawing of a structural overview of an ultraviolet irradiating-drying unit in the electrophotographic printer according to the embodiment.

FIG. 3 is a schematic drawing of a structural overview of the ultraviolet irradiating-drying unit and a fixing device in the electrophotographic printer according to the embodiment.

FIG. 4 is a flow chart of a printing method according to the embodiment.

### DETAILED DESCRIPTION OF EMBODIMENT

Hereinafter, an embodiment of this disclosure are described in detail referring to the accompanying drawings. It should be understood that none of the technical aspects disclosed herein is limited by the embodiment. Structural and technical elements described in the embodiment below may include elements that are replaceable and easily feasible by those skilled in the art and elements that are substantially identical. Further, the structural and technical elements described herein may be suitably combined and if there are a plurality of embodiments, the embodiments may be combined.

### Embodiment

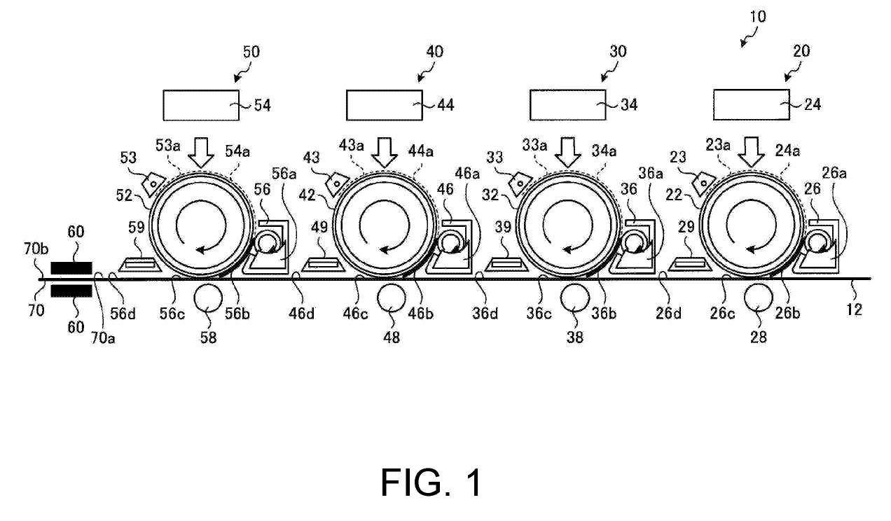

FIG. 1 is a drawing schematically illustrating a structural overview of an electrophotographic printer 10 according to an embodiment. As illustrated in FIG. 1, the electrophotographic printer 10 includes a first color printing means 20, a second color printing means 30, a third color printing means 40, a fourth color printing means 50, and a fixing device 60. In the electrophotographic printer 10, the first color printing means 20, second color printing means 30, third color printing means 40, fourth color printing means 50, and fixing device 60 are arranged in this order from the upstream side toward the downstream side of a transport path on which a print target medium 12 is transported. These color printing means and the fixing device are disposed so as to face a print target surface of the print target medium 12. The print target medium 12 is transported on a predetermined transport path by a transport device not illustrated in the drawing.

The first color printing means 20 prints an image of a first color on the print target medium 12. The second color printing means 30 prints an image of a second color on the print target medium 12 having the first color image printed thereon. The third color printing means 40 prints an image of a third color on the print target medium 12 having the first and second color images printed thereon. The fourth color printing means 50 prints an image of a fourth color on the print target medium 12 having the first, second, and third color images printed thereon. The fixing device 60 fixes the images of the first, second, third, and fourth colors, which have been sequentially printed on the print target medium 12, onto the print target medium 12. Thus, the electrophotographic printer 10 performs sequential color printing, i.e., prompts the first color printing means 20, second color printing means 30, third color printing means 40, and fourth color printing means 50 to sequentially print the images of the first, second, third, and fourth colors on the print target medium 12, and then prompts the fixing device 60 to fix the printed images onto the print target medium 12 so as to obtain a printed matter 70.

An exemplified combination of the first, second, third, and fourth colors in the electrophotographic printer 10 is combination of C (Cyan), M (Magenta), Y (Yellow), and K (Black). The combination of the first, second, third, and fourth colors in the electrophotographic printer 10 may be a combination of different colors arranged in the order of transparency. The combination of the first, second, third, and fourth colors used in the electrophotographic printer 10 is not limited to the YMCK combination and may be selected from other color combinations, an example of which may be combination of R (Red), G (Green), and B (Blue).

The first color printing means 20 is hereinafter described referring to FIG. 1. The first color printing means 20 is substantially configured similarly to the second color printing means 30, third color printing means 40, and fourth color printing means 50. Therefore, any technical aspects that are distinct among the first color printing means 20, second color printing means 30, third color printing means 40, and fourth color printing means 50 alone are hereinafter described, while redundant description of other similar or identical technical aspects may be omitted.

As illustrated in FIG. 1, the first color printing means 20 has an electrophotographic photoconductor 22, an electrifier 23, an image exposure unit 24, a toner developing unit 26, a toner image transfer unit 28, and an ultraviolet irradiating-drying unit 29.

The electrophotographic photoconductor 22 is a cylindrical drum. The electrophotographic photoconductor 22 is disposed along a direction parallel to the width direction of the print target medium 12, and the axial direction of the electrophotographic photoconductor 22 is orthogonal to the transport direction of the print target medium 12. The outer peripheral surface of the electrophotographic photoconductor 22 is facing, at a predetermined position, the print target surface of the print target medium 12 being transported. The electrophotographic photoconductor 22 is provided with a rotation driver to allow for clockwise rotation, as illustrated in FIG. 1. In the description below, the clockwise direction of the electrophotographic photoconductor 22 may be referred to as direction of normal rotation, while the counterclockwise direction of the electrophotographic photoconductor 22 may be referred to as direction of reverse rotation.

At the predetermined position at which the outer peripheral surface of the electrophotographic photoconductor 22 is facing the print target surface of the print target medium 12 being transported, the toner image transfer unit 28, which will be described later, is disposed at a position opposite to the predetermined position across the print target medium 12. The electrifier 23, image exposure unit 24, and toner developing unit 26, which will be described later, are sequentially arranged at positions away from the predetermined position along the direction of normal rotation so as to face the electrophotographic photoconductor 22. The electrophotographic photoconductor 22 rotates and accordingly sequentially and iteratively pass the positions of the electrifier 23, image exposure unit 24, toner developing unit 26, and toner image transfer unit 28 facing the electrophotographic photoconductor 22.

The electrophotographic photoconductor 22 is electrified by electric discharge. The electrophotographic photoconductor 22 is allowed to control the amount of electric charges through light photoconductivity. The electrophotographic photoconductor 22 may be made of, for example, an organic or inorganic photoconductive insulating material.

The electrifier 23 is disposed so as to face the outer peripheral surface of the electrophotographic photoconductor 22 at a position more toward the direction of normal rotation than the position at which the electrophotographic photoconductor 22 is facing the print target medium 12. The electrifier 23 is a member that generates electric discharge. An example of the electrifier 23 may be an electric discharge wire that generates corona discharge.

The electrifier 23 generates electric discharge toward the outer peripheral surface of the electrophotographic photoconductor 22 and thereby electrifies the outer peripheral surface of the electrophotographic photoconductor 22. By thus generating electric discharge toward the outer peripheral surface of the electrophotographic photoconductor 22, the electrifier 23 applies electric charges 23a to the outer peripheral surface of the electrophotographic photoconductor 22. Of the whole outer peripheral surface of the electrophotographic photoconductor 22, the electrifier 23 applies the electric charges 23a to a part of the outer peripheral surface more toward the direction of normal rotation than the position of the electrifier 23. The polarity of the electric charges 23a may be suitably selected in accordance with the electrophotographic photoconductor 22 actually used.

The image exposure unit 24 is disposed so as to face the outer peripheral surface of the electrophotographic photoconductor 22 at a position more toward the direction of normal rotation than the position at which the electrophotographic photoconductor 22 is facing the electrifier 23. A controller, not illustrated in the drawing, is electrically coupled to the image exposure unit 24 so as to receive, from the controller, data of a first color image part included in full color image data. The image exposure unit 24 is a member that radiates light for exposure based on the data of the first color image part received from the controller. Examples of the image exposure unit 24 may include a semiconductor laser and an LED array.

After the electric charges 23a are applied to the outer peripheral surface of the electrophotographic photoconductor 22 by the electrifier 23, the image exposure unit 24 irradiates the outer peripheral surface with light for exposure, and thereby forms a latent charge image 24a based on the data of the first color image part on the outer peripheral surface of the electrophotographic photoconductor 22. Of the whole outer peripheral surface of the electrophotographic photoconductor 22, the image exposure unit 24 forms the latent charge image 24a on a part of the outer peripheral surface more toward the direction of normal rotation than the position of the image exposure unit 24.

The toner developing unit 26 is disposed so as to face the outer peripheral surface of the electrophotographic photoconductor 22 at a position more toward the direction of normal rotation than the position at which the electrophotographic photoconductor 22 is facing the image exposure unit 24. The toner developing unit 26 contains, in its inner space, a liquid toner 26a of the first color. The toner developing unit 26 containing the liquid toner 26a has an electrostatic adsorption mechanism that electrostatically adsorbs the liquid toner 26a to the outer peripheral surface of the electrophotographic photoconductor 22.

The toner developing unit 26 electrostatically adsorbs the liquid toner 26a to the latent charge image 24a formed by the image exposure unit 24 on the outer peripheral surface of the electrophotographic photoconductor 22 so as to develop a toner image 26b of the first color based on the liquid toner 26a. In this embodiment, the toner developing unit 26 develops the toner image 26b by reversal development, which is, however, not limited. The toner image 26b may be developed by normal development. The toner developing unit 26 may apply a direct current bias voltage or an alternate current bias voltage for image development. Of the whole outer peripheral surface of the electrophotographic photoconductor 22, the toner developing unit 26 forms the toner image 26b on a part of the outer peripheral surface more toward the direction of normal rotation than the position of the toner developing unit 26.

The liquid toner 26a includes a coloring ink that produces the first color, an ultraviolet absorbent, a solvent, and a dispersing agent. In the liquid toner 26a, the coloring ink that produces the first color and the ultraviolet absorbent are dispersed in the solvent by the dispersing agent. In the liquid toner 26a, solid particles in the coloring ink have an average particle size less than or equal to 2.0 μm, preferably less than or equal to 1.5 μm, more preferably less than or equal to 1.0 μm. As for an ultraviolet absorption index that refers to the ratio of light absorption energy in the ultraviolet absorption band to the whole light absorption energy, the ultraviolet absorption index of the liquid toner 26a in one toner layer is greater than or equal to 70%, preferably greater than or equal to 80%, more preferably greater than or equal to 90%.

To adjust the surface tension or viscosity of the liquid toner 26a, an adjuster, such as a solvent, may be further added to the liquid toner 26a. The liquid toner 26a may further include an additive such as silicon oxide powder. A semiconductor or insulator of metal sulfide or metal oxide such as zinc oxide having no large absorption band within the visible light region, i.e., having a band gap greater than or equal to 3.1 eV, may be further added to the liquid toner 26a in the form of particles having an average particle size less than or equal to 300 nm, provided that the conversion of absorbed ultraviolet light into visible light or infrared light has a poor conversion efficiency, and most of absorbed ultraviolet light is convertible into heat.

Examples of the coloring ink may include white-colored, cyan (C), magenta (M), yellow (Y), and black (K) inks. The coloring ink may be used in combination with a transparent ink. The transparent ink may be a coloring material having a feature color, for example, a clear ink. The coloring ink is not limited to these examples and may be selected from feature color inks such as red (R), green (G), blue (B), pearl color, and metallic color inks. The coloring ink is not necessarily limited to inks of any particular colors insofar as at least one color or more is thereby producible. As for the coloring ink used in the liquid toner 26a, the coloring ink that produces the first color may be singly used or other coloring ink(s) or transparent ink may be used in combination so as to produce the first color.

Examples of the ultraviolet absorbent may include acetopheminone-based ultraviolet absorbents, α-aminoacetophenone-based ultraviolet absorbents, acylphosphine oxide radical-based ultraviolet absorbents, O-acyloxime-based ultraviolet absorbents, titanocene-based ultraviolet absorbents, radical ultraviolet absorbents such as bimolecular reaction ultraviolet absorbents, and cationic ultraviolet absorbents. The ultraviolet absorbent desirably used may be characterized in that light in the visible light region is limitedly absorbable only to such an extent that does not compromise a color(s) produced by the coloring material, and as much light as possible in the ultraviolet region is absorbable. The ultraviolet absorbent may excel in chemical stability and color stability against heat generated by instantaneous heating. The ultraviolet absorbent has an absorption band effective for light in the ultraviolet absorption band having a wavelength less than or equal to 400 nm, preferably less than or equal to 385 nm, more preferably less than or equal to 365 nm.

Examples of the solvent may include glycol ethers and glycol ether acetates, such as propylene glycol monomethyl ether, ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propyleneglycol monomethyl ether acetate, dipropylene glycol monomethyl ether acetate, ethylene glycol monomethyl ether propionate, ethylene glycol monoethyl ether propionate, ethylene glycol monobutyl ether propionate, diethylene glycol monomethyl ether propionate, diethylene glycol monoethyl ether propionate, diethylene glycol monobutyl ether propionate, propyleneglycol monomethyl ether propionate, dipropylene glycol monomethyl ether propionate, ethylene glycol monomethyl ether butyrate, ethylene glycol monoethyl ether butyrate, ethylene glycol monobutyl ether butyrate, diethylene glycol monomethyl ether butyrate, diethylene glycol monoethyl ether butyrate, diethylene glycol monobutyl ether butyrate, propyleneglycol monomethyl ether butyrate, and dipropylene glycol monomethyl ether butyrate.

The solvent may be an optional one selected from hydrocarbon-based solvents, for example, n-hexane, n-heptane, n-octane, isooctane, cyclohexane, methylcyclohexane, benzene, toluene, o-xylene, m-xylene, p-xylene, and ethylbenzene. The solvent may be an optional one selected from ester-based solvents, for example, propyl formate, n-butyl formate, isobutyl formate, amyl formate, ethyl acetate, n-propyl acetate, isopropyl acetate, n-butyl acetate, isobutyl acetate, secondary butyl acetate, n-amyl acetate, isoamyl acetate, methyl isoamyl acetate, secondary hexyl acetate, methyl propionate, ethyl propionate, n-butyl propionate, methyl butyrate, ethyl butyrate, methyl lactate, and γ-butyrolactone. The solvent may be an optional one selected from ketone-based solvents, for example, methylethylketone, methyl-n-propylketone, methyl-n-butylketone, methylisobutylketone, diethylketone, ethyl-n-butylketone, di-n-propylketone, and mesityl oxide.

The solvent may be any one selected from these examples that can be evaporated by heating. The solvent desirably used may be characterized in that light in the visible light region is limitedly absorbable only to such an extent that does not compromise a color(s) produced by the coloring material. Further, the solvent may excel in chemical stability and color stability against heat generated by instantaneous heating.

Examples of the dispersing agents may include polymeric dispersing agents and surfactants having hydrophilic and hydrophobic groups. Examples of the polymeric dispersing agents may include non-aqueous surfactants, aqueous surfactants, and aqueous and non-aqueous surfactants. Examples of the non-aqueous surfactants may include unsaturated polycarboxylic acid and unsaturated polyamide polycarboxylate. Examples of the aqueous surfactants may include polycarboxylic acid alkylamine salt and nonionic surfactants. Examples of the surfactants having hydrophilic and hydrophobic groups may include anionic surfactants, cationic surfactants, nonionic surfactants, and anionic and cationic surfactants. The dispersing agent desirably used may be characterized in that light in the visible light region is limitedly absorbable only to such an extent that does not compromise a color(s) produced by the coloring material. Further, the dispersing agent may excel in chemical stability and color stability against heat generated by instantaneous heating.

The toner image transfer unit 28 is disposed at a position more toward the direction of normal rotation than the position at which the electrophotographic photoconductor 22 is facing the toner developing unit 26. The toner image transfer unit 28 is disposed opposite to, on the other side of the print target surface of the print target medium 12, the predetermined position at which the outer peripheral surface of the electrophotographic photoconductor 22 is facing the print target surface of the print target medium 12 being transported. Thus, the toner image transfer unit 28 and the electrophotographic photoconductor 22 are positioned so that the print target medium 12 is interposed therebetween. The toner image transfer unit 28 has a voltage applicator that applies voltage whose polarity differs from that of the electrifier 23.

The toner image transfer unit 28, through voltage application using, for example, voltage generated by corona discharge or voltage applied to a roller, applies an electrostatic force directed toward the print target medium 12 to the toner image 26b formed on the outer peripheral surface of the electrophotographic photoconductor 22. The toner image transfer unit 28, using the electrostatic force, peels the toner image 26b off the outer peripheral surface of the electrophotographic photoconductor 22 and transfers the toner image 26b to the print target surface of the print target medium 12 so as to form a toner image 26c of the first color on the print target surface of the print target medium 12. Of the whole outer peripheral surface of the electrophotographic photoconductor 22, the toner image transfer unit 28 peels off the toner image 26b from a part of the outer peripheral surface more toward the direction of normal rotation than the position of the toner image transfer unit 28.

The first color printing means 20 prompts the toner image transfer unit 28 to transfer the toner image to the print target medium 12 directly from the outer peripheral surface of the electrophotographic photoconductor 22. The toner image transfer is not necessarily limited to such direct transfer and may be indirect transfer. The toner image may be transferred from the outer peripheral surface of the electrophotographic photoconductor 22 to a transfer belt or a transfer drum before the transfer to the print target medium 12.

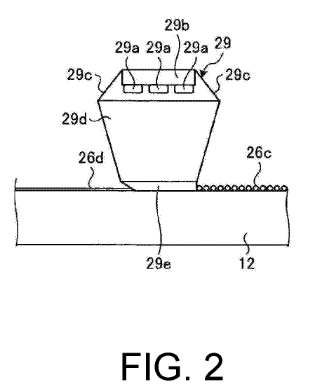

The ultraviolet irradiating-drying unit 29 is disposed so as to face the print target surface of the print target medium 12 at a position more downstream than the position of the toner image transfer unit 28 on the transport path of the print target medium 12. FIG. 2 is a schematic drawing of a structural overview of the ultraviolet irradiating-drying unit 29 in the electrophotographic printer 10 according to the embodiment. As illustrated in FIG. 2, the ultraviolet irradiating-drying unit 29 has ultraviolet emitting diodes 29a, a heat release base plate 29b, and an ultraviolet reflective plate 29c.

The ultraviolet irradiating-drying unit 29 has three ultraviolet emitting diodes 29a. The number of the ultraviolet emitting diodes is not limited to three and may be one, two, or four or more. The ultraviolet emitting diodes 29a of the ultraviolet irradiating-drying unit 29 may be replaced with or may be used in combination with a metal halide lamp or a xenon lamp that emits light including ultraviolet light. All of the ultraviolet emitting diodes 29a are facing the print target surface of the print target medium 12 and radiate ultraviolet light 29d toward the print target surface of the print target medium 12. In the ultraviolet irradiating-drying unit 29, the ultraviolet emitting diodes 29a may be evenly spaced at intervals and directed toward the print target surface of the print target medium 12.

The ultraviolet emitting diodes 29a radiate the ultraviolet light 29d having an ultraviolet irradiation band including part of the ultraviolet absorption band of the ultraviolet absorbent in the liquid toner 26a. All of the ultraviolet emitting diodes 29a may be configured to radiate the ultraviolet light 29d having an ultraviolet irradiation band of a similar range to the ultraviolet absorption band of the ultraviolet absorbent in the liquid toner 26a. All of the ultraviolet emitting diodes 29a is preferably configured to radiate the ultraviolet light 29d having a center wavelength less than or equal to 385 nm, more preferably less than or equal to 365 nm in the ultraviolet irradiation band, depending on a center wavelength in the ultraviolet absorption band of the ultraviolet absorbent.

There is one heat release base plate 29b for the plural ultraviolet emitting diodes 29a, and the heat release base plate 29b is disposed in contact with the ultraviolet emitting diodes 29a on one side of these diodes opposite to their other side directed toward the print target surface of the print target medium 12. The heat release base plate 29b is made of a ceramic material or a metallic material having high thermal conductivity, and releases heat generated in the ultraviolet emitting diodes 29a.

The ultraviolet reflective plate 29c is disposed so as to cover, from the outer side of the heat release base plate 29b, the ultraviolet emitting diodes 29a on one side of these diodes opposite to their other side directed toward the print target surface of the print target medium 12. The ultraviolet light 29d radiated from the ultraviolet emitting diodes 29a in the opposite direction of the print target surface of the print target medium 12 is reflected by the ultraviolet reflective plate 29, so that the ultraviolet light 29d is turned around toward the print target surface of the print target medium 12.

The ultraviolet irradiating-drying unit 29 thus configured irradiates the print target surface of the print target medium 12 having the toner image 26c formed thereon by the toner image transfer unit 28 with the ultraviolet light 29d. The ultraviolet irradiating-drying unit 29 accordingly forms an ultraviolet irradiating region 29e to be irradiated with the ultraviolet light 29d on the print target surface of the print target medium 12. The ultraviolet irradiating-drying unit 29, using the ultraviolet light 29d, heats the ultraviolet absorbent included in the toner image 26c passing through the ultraviolet irradiating region 29e, and thereby evaporates the solvent included in the toner image 26c to dry the toner image 26c, so that a dried toner image 26d of the first color is formed on the print target surface of the print target medium 12.

The ultraviolet irradiating-drying unit 29 may irradiate the toner image with the ultraviolet light 29d with an accumulative irradiation energy greater than or equal to 600 mJ/cm²·g and less than or equal to 10000 mJ/cm²·g. The accumulative irradiation energy described herein refers to an integrated energy value of the ultraviolet light 29d with which the toner image 26c per unit area is irradiated. The ultraviolet emitting diodes 29a of the ultraviolet irradiating-drying unit 29 may intermittently radiate the ultraviolet light 29d at shorter time intervals than time required for the print target medium 12 to pass through the ultraviolet irradiating region 29e.

As illustrated in FIG. 1, the second color printing means 30 has an electrophotographic photoconductor 32, an electrifier 33, an image exposure unit 34, a toner developing unit 36, a toner image transfer unit 38, and an ultraviolet irradiating-drying unit 39. By generating electric discharge toward the outer peripheral surface of the electrophotographic photoconductor 32, the electrifier 33 applies electric charges 33a to the outer peripheral surface of the electrophotographic photoconductor 32. After the electric charges 33a are applied to the outer peripheral surface of the electrophotographic photoconductor 32 by the electrifier 33, the image exposure unit 34 irradiates the outer peripheral surface with light for exposure, and thereby forms a latent charge image 34a based on data of a second color image part on the outer peripheral surface of the electrophotographic photoconductor 32. The toner developing unit 36 electrostatically adsorbs a liquid toner 36a to the latent charge image 34a formed by the image exposure unit 34 on the outer peripheral surface of the electrophotographic photoconductor 32 so as to develop a toner image 36b of the second color based on the liquid toner 36a. The toner image transfer unit 38 peels the second color toner image 36b off the outer peripheral surface of the electrophotographic photoconductor 32 and transfers the toner image 36b onto the dried toner image 26d of the first color on the print target surface of the print target medium 12 so as to form a toner image 36c of the second color on the dried toner image 26d of the first color. The ultraviolet irradiating-drying unit 39 dries the toner image 36c of the second color and thereby forms a dried toner image 36d of the second color on the dried toner image 26d of the first color.

As illustrated in FIG. 1, the third color printing means 40 has an electrophotographic photoconductor 42, an electrifier 43, an image exposure unit 44, a toner developing unit 46, a toner image transfer unit 48, and an ultraviolet irradiating-drying unit 49. By generating electric discharge toward the outer peripheral surface of the electrophotographic photoconductor 42, the electrifier 43 applies electric charges 43a to the outer peripheral surface of the electrophotographic photoconductor 42. After the electric charges 43a are applied to the outer peripheral surface of the electrophotographic photoconductor 42 by the electrifier 43, the image exposure unit 44 irradiates the outer peripheral surface with light for exposure, and thereby forms a latent charge image 44a based on data of a third color image part on the outer peripheral surface of the electrophotographic photoconductor 42. The toner developing unit 46 electrostatically adsorbs a liquid toner 46a to the latent charge image 44a formed by the image exposure unit 44 on the outer peripheral surface of the electrophotographic photoconductor 42 so as to develop a toner image 46b of the third color based on the liquid toner 46a. The toner image transfer unit 48 peels the third color toner image 46b off the outer peripheral surface of the electrophotographic photoconductor 42 and transfers the toner image 46b onto the dried toner image 36d of the second color on the print target surface of the print target medium 12 so as to form a toner image 46c of the third color on the dried toner image 36d of the second color. The ultraviolet irradiating-drying unit 49 dries the toner image 46c of the third color and thereby forms a dried toner image 46d of the third color on the dried toner image 36d of the second color.

As illustrated in FIG. 1, the fourth color printing means 50 has an electrophotographic photoconductor 52, an electrifier 53, an image exposure unit 54, a toner developing unit 56, a toner image transfer unit 58, and an ultraviolet irradiating-drying unit 59. By generating electric discharge toward the outer peripheral surface of the electrophotographic photoconductor 52, the electrifier 53 applies electric charges 53a to the outer peripheral surface of the electrophotographic photoconductor 52. After the electric charges 53a are applied to the outer peripheral surface of the electrophotographic photoconductor 52 by the electrifier 53, the image exposure unit 54 irradiates the outer peripheral surface with light for exposure, and thereby forms a latent charge image 54a based on data of a fourth color image part on the outer peripheral surface of the electrophotographic photoconductor 52. The toner developing unit 56 electrostatically adsorbs a liquid toner 56a to the latent charge image 54a formed by the image exposure unit 54 on the outer peripheral surface of the electrophotographic photoconductor 52 so as to develop a toner image 56b of the fourth color based on the liquid toner 56a. The toner image transfer unit 58 peels the fourth color toner image 56b off the outer peripheral surface of the electrophotographic photoconductor 52 and transfers the toner image 56b onto the dried toner image 46d of the third color on the print target surface of the print target medium 12 so as to form a toner image 56c of the fourth color on the dried toner image 46d of the third color. The ultraviolet irradiating-drying unit 59 dries the toner image 56c of the fourth color and thereby forms a dried toner image 56d of the fourth color on the dried toner image 46d of the third color.

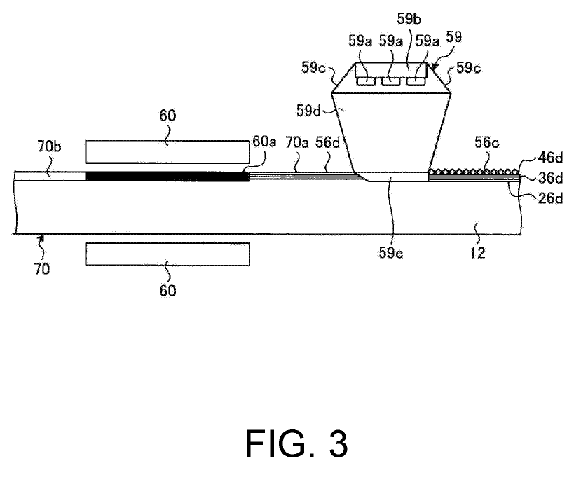

FIG. 3 is a schematic drawing of a structural overview of the ultraviolet irradiating-drying unit 59 and the fixing device 60 in the electrophotographic printer 10 according to the embodiment. As illustrated in FIG. 3, the ultraviolet irradiating-drying unit 59 has ultraviolet emitting diodes 59a, a heat release base plate 59b, and an ultraviolet reflective plate 59c.

After the dried toner image 26d of the first color, dried toner image 36d of the second color, and dried toner image 46d of the third color are formed on the print target surface of the print target medium 12 and the toner image 56c of the fourth color is further formed thereon by the toner image transfer unit 58, the ultraviolet irradiating-drying unit 59 radiates ultraviolet light 59d toward the print target surface of the print target medium 12. The ultraviolet irradiating-drying unit 59 accordingly forms an ultraviolet irradiating region 59e to be irradiated with the ultraviolet light 59d on the print target surface of the print target medium 12. The ultraviolet irradiating-drying unit 59, using the ultraviolet light 59d, heats the ultraviolet absorbent included in the toner image 56c passing through the ultraviolet irradiating region 59e, and thereby evaporates the solvent included in the toner image 56c to dry the toner image 56c, so that the dried toner image 56d of the fourth color is formed on the dried toner image 46d of the third color previously formed on the print target surface of the print target medium 12. After the print target medium 12 is caused to pass through the ultraviolet irradiating region 59e formed by the ultraviolet irradiating-drying unit 59, the print target medium 12 has, on its print target surface sequentially, the different dried toner images formed on one another; dried toner image 26d of the first color, dried toner image 36d of the second color, dried toner image 46d of the third color, and dried toner image 56d of the fourth color. On the print target surface of the print target medium 12, a composite dried toner image 70a is thus formed that sequentially includes the dried toner image 26d, dried toner image 36d, dried toner image 46d, and dried toner image 56d.

As illustrated in FIGS. 1 and 3, the fixing device 60 is disposed at a position more downstream than the position of the ultraviolet irradiating-drying unit 59 on the transport path of the print target medium 12. The fixing device 60 is a pair of heaters. One of the heaters is disposed in proximity to and facing the print target surface of the print target medium 12, while the other heater is disposed in proximity to and facing the other surface of the print target medium 12 on the opposite side of the print target surface. The fixing device 60 is not limited to a pair of heaters and may be a suitable one selected from the conventional heating devices. The fixing device 60 collectively heats the multiple images of the composite dried toner image 70a passing through a heating region 60a formed by the pair of heaters. In the heating region 60a, the fixing device 60 combines the multiple images of the composite dried toner image 70a into one print image 70b and fixes the print image 70b to the print target surface of the print target medium 12. As a result, a printed matter 70 with the print image 70b printed thereon is obtained.

The fixing device 60 may use ultraviolet irradiating means similar to the ones used in the ultraviolet irradiating-drying unit 29, ultraviolet irradiating-drying unit 39, ultraviolet irradiating-drying unit 49, and ultraviolet irradiating-drying unit 59. In case where the fixing device 60 is thus configured, ultraviolet light is radiated from the fixing device 60 and absorbed by the ultraviolet absorbent included in the composite dried toner image 70a passing through the heating region 60a, which is the ultraviolet irradiating region, formed by the fixing device 60, so that the multiple images of the composite dried toner image 70a are collectively heated.

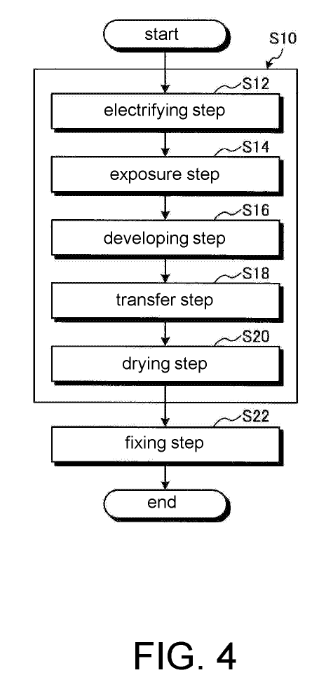

FIG. 4 is a flow chart of a printing method according to the embodiment. The printing method is an exemplified method of operating the electrophotographic printer 10 according to the embodiment. This printing method is hereinafter described referring to FIG. 4. As illustrated in FIG. 4, the printing method according to the embodiment includes a single-color printing step (Step S10) and a fixing step (Step S22). The printing method according to the embodiment includes a plurality of single-color printing steps (Step S10) for the number of colors to be printed. In this embodiment, the printing method includes four single-color printing steps. The single-color printing steps (Step S10) each include an electrifying step (Step S12), an exposure step (Step S14), a developing step (Step S16), a transfer step (Step S18), and a drying step (Step S20).

First, the print target medium 12 is transported on a predetermined transport path by a transport device not illustrated in the drawing. The first color printing means 20, second color printing means 30, third color printing means 40, and fourth color printing means 50 respectively perform Steps S10 one after another with respect to the print target surface of the print target medium 12 being transported on the predetermined transport path. The description given below mostly focuses on Step S10 performed by the first color printing means 20, while omitting detailed description of Steps S10 by the second color printing means 30, third color printing means 40, and fourth color printing means 50.

By generating electric discharge toward the outer peripheral surface of the electrophotographic photoconductor 22, the electrifier 23 of the first color printing means 20 electrifies the outer peripheral surface of the electrophotographic photoconductor 22 and applies the electric charges 23a to the outer peripheral surface of the electrophotographic photoconductor 22 (Step S12).

Subsequent to Step S12, the image exposure unit 24 of the first color printing means 20 receives the data of the first color image part included in full color image data from the controller electrically coupled to the image exposure unit 24. After the electric charges 23a are applied to the outer peripheral surface of the electrophotographic photoconductor 22 by the electrifier 23, the image exposure unit 24 irradiates the outer peripheral surface with light for exposure based on the data of the first color image part received from the controller, and thereby forms the latent charge image 24a based on the data of the first color image part on the outer peripheral surface of the electrophotographic photoconductor 22 (Step S14).

The toner developing unit 26 of the first color printing means 20 contains the liquid toner 26a of the first color including the ultraviolet absorbent in its inner space. Subsequent to Step S14, the toner developing unit 26 electrostatically adsorbs the liquid toner 26a to the latent charge image 24a formed by the image exposure unit 24 on the outer peripheral surface of the electrophotographic photoconductor 22. As a result of these steps, the toner developing unit 26 forms the toner image 26b of the first color based on the liquid toner 26a on the outer peripheral surface of the electrophotographic photoconductor 22 (Step S16).

Subsequent to Step S16, the toner image transfer unit 28 of the first color printing means 20, through voltage application, applies an electrostatic force directed toward the print target medium 12 to the toner image 26b formed on the outer peripheral surface of the electrophotographic photoconductor 22. The toner image transfer unit 28, using the electrostatic force, peels the toner image 26b off the outer peripheral surface of the electrophotographic photoconductor 22 and transfers the toner image 26b to the print target surface of the print target medium 12, so that the toner image 26c of the first color is formed on the print target surface of the print target medium 12 (Step S18).

Subsequent to Step S18, the ultraviolet emitting diodes 29a in the ultraviolet irradiating-drying unit 29 of the first color printing means 20 irradiate the print target surface of the print target medium 12 having the toner image 26c formed thereon by the toner image transfer unit 28 with the ultraviolet light 29d having an ultraviolet irradiation band including part of the ultraviolet absorption band of the ultraviolet absorbent in the liquid toner 26a. The ultraviolet irradiating-drying unit 29 accordingly forms the ultraviolet irradiating region 29e to be irradiated with the ultraviolet light 29d on the print target surface of the print target medium 12. The ultraviolet irradiating-drying unit 29, using the ultraviolet light 29d, heats the ultraviolet absorbent included in the toner image 26c passing through the ultraviolet irradiating region 29e, and thereby evaporates the solvent included in the toner image 26c to dry the toner image 26c, so that the dried toner image 26d of the first color is formed on the print target surface of the print target medium 12 (Step S20).

Thus, the first color printing means 20 forms the dried toner image 26d of the first color on the print target surface of the print target medium 12 (Step S10). The second color printing means 30, by performing processing steps similar to Step S12 to Step 20 described above, forms the dried toner image 36d of the second color on the dried toner image 26d of the first color previously formed on the print target surface of the print target medium 12 (Step S10). The third color printing means 40, by performing processing steps similar to Step S12 to Step 20 described above, forms the dried toner image 46d of the third color on the dried toner image 36d of the second color previously formed on the print target surface of the print target medium 12 (Step S10). The fourth color printing means 50, by performing processing steps similar to Step S12 to Step 20 described above, forms the dried toner image 56d of the fourth color on the dried toner image 46d of the third color previously formed on the print target surface of the print target medium 12 (Step S10). Thus, the second color printing means 30, third color printing means 40, and fourth color printing means 50 similarly perform Steps S10 one after another, so that the composite dried toner image 70a sequentially including the dried toner images 26d, 36d, 46d, and 56d is formed on the print surface of the print target medium 12.

After Steps S10 are completed for all of the colors, the fixing device 60 collectively heats the multiple images of the composite dried toner image 70a formed on the print target surface of the print target medium 12 passing through the heating region 60a. In the heating region 60a, the fixing device 60 combines the multiple images of the composite dried toner image 70a into one print image 70b and fixes the print image 70b to the print target surface of the print target medium 12. As a result, the printed matter 70 with the print image 70b printed thereon is obtained (Step S22).

The electrophotographic printer 10 and the printing method using the same are configured and characterized as described thus far. The liquid toners 26a, 36a, 46a, and 56a each containing the ultraviolet absorbent for absorption of ultraviolet light are adsorbed to the latent charge images so as to develop the toner images 26b, 36b, 46b, and 56b, and these toner images are then transferred onto the print target medium 12. The transferred toner images 26c, 36c, 46c, and 56c are dried by being irradiated with ultraviolet light having an ultraviolet irradiation band including part of the ultraviolet absorption band of the ultraviolet absorbent in the liquid toners 26a, 36a, 46a, and 56a. As a result, the dried toner images 26d, 36d, 46d, and 56d are formed. In the electrophotographic printer 10 and the printing method using the same, the printing materials used are the liquid toners 26a, 36a, 46a, and 56a in which solid particles of the coloring ink have an average particle size less than or equal to 2.0 μm. Therefore, improvement of image quality may be feasible in contrast to use of, for example, a powder toner containing rather angular particles, i.e., less spherical particles having a relatively large average particle size of approximately 5.5 μm.

In the electrophotographic printer 10 and the printing method using the same, the printing materials used are the liquid toners 26a, 36a, 46a, and 56a characterized in that, as for an ultraviolet absorption index that refers to the ratio of light absorption energy in the ultraviolet absorption band to the whole light absorption energy, the ultraviolet absorption index in one toner layer is greater than or equal to 70%, and the absorption band is effective for light in the ultraviolet absorption band having a wavelength less than or equal to 400 nm. Further, these liquid toners are irradiated with ultraviolet light from the ultraviolet irradiating-drying units 29, 39, 49, and 59 having an ultraviolet irradiation band including part of the ultraviolet absorption band of the ultraviolet absorbent in the liquid toners 26a, 36a, 46a, and 56a. The electrophotographic printer 10 and the printing method using the same, therefore, may allow the toner images 26c, 36c, 46c, and 56c to readily dry without much heating of the print target medium 12 that hardly absorbs ultraviolet light. This may reduce the risk of the print target medium 12 being thermally deformed. The electrophotographic printer 10 and the printing method using the same may reduce the risk of paper jam and may also reduce the risk of heat-induced discoloration of the toner images 26c, 36c, 46, and 56c. The electrophotographic printer 10 and the printing method using the same may achieve an improved image quality, while reducing the risk of the print target medium 12 being deformed.

In the electrophotographic printer 10 and the printing method using the same, the printing materials used are the liquid toners 26a, 36a, 46a, and 56a in which solid particles in the coloring inks preferably have an average particle size less than or equal to 1.5 μm, more preferably less than or equal to 1.0 μm. Improvement of image quality, therefore, may be feasible with the electrophotographic printer 10 and the printing method using the same.

In the electrophotographic printer 10 and the printing method using the same, the printing material used are the liquid toners 26a, 36a, 46a, and 56a characterized in that, as for an ultraviolet absorption index that refers to the ratio of light absorption energy in the ultraviolet absorption band to the whole light absorption energy, the ultraviolet absorption index in one toner layer may be greater than or equal to 80% or greater than or equal to 90%. The electrophotographic printer 10 and the printing method using the same, therefore, may allow the toner images 26c, 36c, 46c, and 56c to efficiently dry, further reducing the risk of the print target medium 12 being thermally deformed.

In the electrophotographic printer 10 and the printing method using the same, the printing materials used are the liquid toners 26a, 36a, 46a, and 56a characterized in that a center wavelength in the ultraviolet absorption band of the ultraviolet absorbent is preferably less than or equal to 385 nm, more preferably less than or equal to 365 nm, and these liquid toners are irradiated with ultraviolet light having a center wavelength in the ultraviolet irradiation band suitable for the liquid toners 26a, 36a, 46a, and 56a. The electrophotographic printer 10 and the printing method using the same, therefore, may allow the toner images 26c, 36c, 46c, and 56c to readily dry with less heating of the print target medium 12. This may further reduce the risk of the print target medium 12 being thermally deformed.

In the electrophotographic printer 10 and the printing method using the same, the ultraviolet irradiating-drying units 29, 39, 49, and 59 are used, in which the ultraviolet emitting diodes may be evenly spaced at intervals and directed toward the print target surface of the print target medium 12. The electrophotographic printer 10 and the printing method using the same, therefore, may evenly heat and dry the toner images 26c, 36c, 46c, and 56c. This may further reduce the risk of the print target medium 12 being thermally deformed.

In the electrophotographic printer 10 and the printing method using the same, ultraviolet light radiated with an accumulated irradiation energy greater than or equal to 600 mJ/cm²·g and less than or equal to 10000 mJ/cm²·g is used. The electrophotographic printer 10 and the printing method using the same, therefore, may allow the toner images 26c, 36c, 46c, and 56c to more efficiently dry with less heating of the print target medium 12. This may further reduce the risk of the print target medium 12 being thermally deformed.

In the electrophotographic printer 10 and the printing method using the same, the ultraviolet irradiating-drying units 29, 39, 49, and 59 intermittently radiate ultraviolet light at shorter time intervals than time required for the print target medium 12 to pass through the ultraviolet irradiating region to dry the toner images 26c, 36c, 46c, and 56c. The electrophotographic printer 10 and the printing method using the same, therefore, may avoid overheating of and radiation loss for the toner images 26c, 36c, 46c, and 56c and may allow the toner images 26c, 36c, 46c, and 56c to more efficiently dry with less heating of the print target medium 12. This may further reduce the risk of the print target medium 12 being thermally deformed.

The electrophotographic printer 10 and the printing method using the same carries out the steps for electrification, exposure, development, transfer, and drying for each color, allowing the toner images to dry immediately after the transfer. This may prevent the liquid toners 26a, 36a, 46a, and 56a from bleeding on the print target medium 12 and allow the dried toner images 26d, 36d, 46d, and 56d to be adequately flattened. In case where the color printing order, the printing color type(s), and/or the number of printing color types is desirably changed, the electrophotographic printer 10 and the printing method using the same may facilitate such changes.

The electrophotographic printer 10 and the printing method using the same heat the composite dried toner image 70a at once and thereby fix the print image 70b onto the print target medium 12. This may provide an integrated multicolor image with a natural color appearance, instead of such an image that appears disorganized in different colors.

What is claimed is:

1. An electrophotographic printer, comprising:
a toner developing unit that adsorbs a liquid toner including an ultraviolet absorbent for absorption of ultraviolet light to a latent charge image so as to develop a toner image;
a toner image transfer unit that transfers the toner image obtained by the toner developing unit onto a print target medium; and
an ultraviolet irradiating-drying unit that irradiates the toner image with ultraviolet light so as to dry the toner image transferred on the print target medium.

2. The electrophotographic printer according to claim 1, comprising a plurality of the toner developing units, a plurality of the toner image transfer units, and a plurality of the ultraviolet irradiating-drying units that are respectively provided for a plurality of different colors, wherein
a plurality of the toner images are sequentially dried per color on the print target medium so as to form a composite dried toner image including the plurality of the toner images dried and having the plurality of different colors on the print target medium.

3. The electrophotographic printer according to claim 2, further comprising a fixing device that heats the print target medium on which the composite dried toner image is formed so as to fix the composite dried toner image onto the print target medium.

4. A printing method, comprising:
a toner developing step of developing a toner image through adsorption of a liquid toner including an ultraviolet absorbent that absorbs ultraviolet light;
a toner image transfer step of transferring the toner image obtained in the toner developing step onto a print target medium; and
an ultraviolet irradiating-drying step of irradiating the toner image with ultraviolet light so as to dry the toner image transferred on the print target medium,
the printing method comprising a plurality of the toner developing steps, a plurality of the toner image transfer steps, and a plurality of the ultraviolet irradiating-drying steps respectively for a plurality of different colors,
the printing method drying a plurality of the toner images sequentially per color on the print target medium so as to form a composite dried toner image including the plurality of the toner images dried and having the plurality of different colors on the print target medium.

5. The printing method according to claim 4, further comprising a fixing step of heating the print target medium on which the composite dried toner image is formed so as to fix the composite dried toner image onto the print target medium.
